(19) United States
(12) Patent Application Publication
(10) Pub. No.: US 2025/0334917 A1
(43) Pub. Date: Oct. 30, 2025

(54) IMAGE FORMING APPARATUS CAPABLE OF SHORTENING INTERVAL OF SHEET FEED OPERATION BY SHEET FEED PORTION, AND DRIVE CONTROL METHOD

(71) Applicant: KYOCERA Document Solutions Inc., Osaka-shi (JP)

(72) Inventor: Haruna Takamura, Osaka (JP)

(21) Appl. No.: 19/189,745

(22) Filed: Apr. 25, 2025

(30) Foreign Application Priority Data
Apr. 30, 2024 (JP) 2024-073310

(51) Int. Cl. G03G 15/00

(52) U.S. Cl. CPC G03G 15/6564; G03G 15/50; G03G 2215/00721

(57) ABSTRACT

An image forming apparatus includes a sheet feed portion and a drive control portion. The sheet feed portion includes a conveying member which is provided more on an upstream side of a conveying direction of a sheet than a transfer position of a toner image on a conveying path of the sheet that passes through the transfer position, and feeds the sheet from a sheet feed position that is more on a downstream side of the conveying direction than the conveying member on the conveying path. The drive control portion drives a stepping motor used for driving the conveying member such that the sheet reaches the sheet feed position at a time a next sheet feed timing by the sheet feed portion arrives.

### INCORPORATION BY REFERENCE

This application is based upon and claims the benefit of priority from the corresponding Japanese Patent Application No. 2024-073310 filed on Apr. 30, 2024, the entire contents of which are incorporated herein by reference.

### BACKGROUND

The present disclosure relates to an image forming apparatus and a drive control method.

An image forming apparatus that uses electrophotography includes a transfer portion and a sheet feed portion. The transfer portion transfers a toner image onto a sheet. The sheet feed portion includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path.

Further, an image forming apparatus including a stepping motor which drives the conveying member is known as the related art. In this image forming apparatus according to the related art, drive of the stepping motor is stopped until a next sheet feed timing by the sheet feed portion arrives since a timing at which the sheet has reached the sheet feed position.

### SUMMARY

An image forming apparatus according to an aspect of the present disclosure includes a transfer portion, a sheet feed portion, a stepping motor, a detection processing portion, and a drive control portion. The transfer portion transfers a toner image onto a sheet. The sheet feed portion includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path. The stepping motor drives the conveying member. The detection processing portion detects the sheet conveyed by the conveying member at a position that is more on the upstream side of the conveying direction than the sheet feed position on the conveying path. The drive control portion drives the stepping motor such that the sheet reaches the sheet feed position at a time a next sheet feed timing by the sheet feed portion arrives based on a detection timing of the sheet by the detection processing portion.

A drive control method according to another aspect of the present disclosure is executed in an image forming apparatus including a transfer portion which transfers a toner image onto a sheet, a sheet feed portion which includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path, and a stepping motor which drives the conveying member, and includes a detection step and a drive control step. The detection step includes detecting the sheet conveyed by the conveying member at a position that is more on the upstream side of the conveying direction than the sheet feed position on the conveying path. The drive control step includes driving the stepping motor such that the sheet reaches the sheet feed position at a time a next sheet feed timing by the sheet feed portion arrives based on a detection timing of the sheet in the detection step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a block diagram showing a system configuration of the image forming apparatus according to the embodiment of the present disclosure;

FIG. 3 is a flowchart showing an example of first sheet feed control processing executed in the image forming apparatus according to the embodiment of the present disclosure; and

FIG. 4 is a flowchart showing an example of second sheet feed control processing executed in the image forming apparatus according to the embodiment of the present disclosure.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### Configuration of Image Forming Apparatus 100

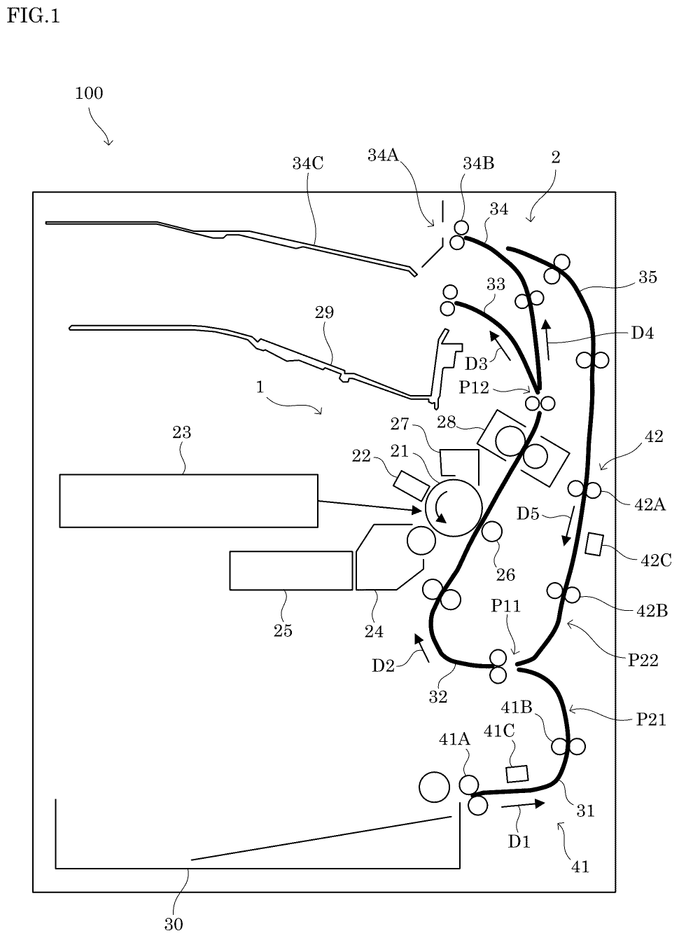

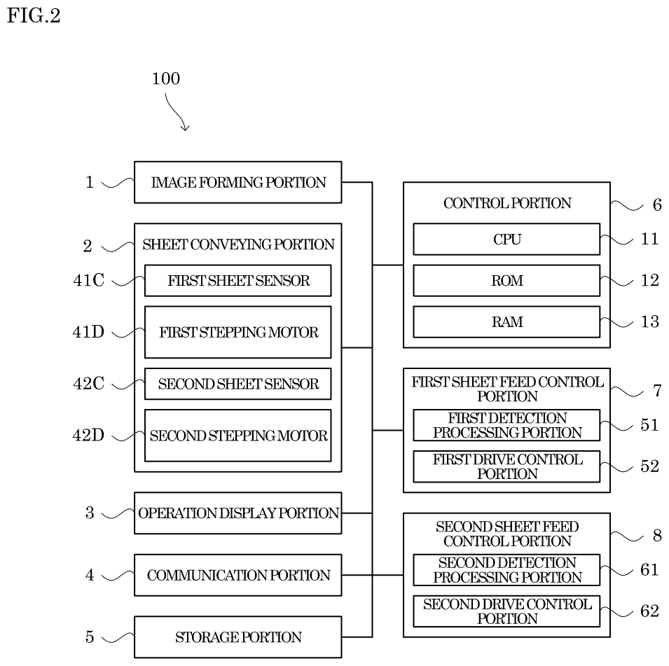

First, a configuration of an image forming apparatus 100 according to the embodiment of the present disclosure will be described with reference to FIG. 1 and FIG. 2. Herein, FIG. 1 is a cross-sectional view showing the configuration of the image forming apparatus 100.

The image forming apparatus 100 is a printer that forms an image on a sheet using electrophotography. It is noted that the present disclosure can be applied to a facsimile apparatus, a copying machine, a multifunction peripheral, and the like that form an image on a sheet using electrophotography.

As shown in FIG. 1 and FIG. 2, the image forming apparatus 100 includes an image forming portion 1, a sheet conveying portion 2, an operation display portion 3, a communication portion 4, a storage portion 5, a control portion 6, a first sheet feed control portion 7, and a second sheet feed control portion 8.

The image forming portion 1 forms an image on a sheet using electrophotography based on image data input from an external information processing apparatus such as a personal computer.

The sheet conveying portion 2 conveys a sheet on which an image is to be formed by the image forming portion 1.

The operation display portion 3 is a user interface of the image forming apparatus 100. The operation display portion 3 includes a display portion and an operation portion. The display portion displays various types of information in response to control instructions from the control portion 6. For example, the display portion is a flat panel display such as a liquid crystal display. The operation portion is used to input various types of information to the control portion 6 according to user operations. For example, the operation portion includes operation keys and a touch panel.

The communication portion 4 is a communication interface that executes wired or wireless data communication with the external information processing apparatus.

The storage portion 5 is a nonvolatile storage device. For example, the storage portion 5 is a nonvolatile memory such as a flash memory.

The control portion 6 collectively controls the image forming apparatus 100. As shown in FIG. 2, the control portion 6 includes a CPU 11, a ROM 12, and a RAM 13. The CPU 11 is a processor that executes various types of arithmetic processing. The ROM 12 is a nonvolatile storage device in which information such as control programs for causing the CPU 11 to execute various types of processing is stored in advance. The RAM 13 is a volatile or nonvolatile storage device that is used as a temporary storage memory (working area) for the various types of processing to be executed by the CPU 11. In the control portion 6, the CPU 11 executes the various control programs stored in advance in the ROM 12. Thus, the control portion 6 collectively controls the image forming apparatus 100.

The first sheet feed control portion 7 controls sheet feed operations by a first sheet feed portion 41 (see FIG. 1) of the sheet conveying portion 2. The first sheet feed control portion 7 is constituted of an electronic circuit such as an integrated circuit (ASIC, DSP).

The second sheet feed control portion 8 controls sheet feed operations by a second sheet feed portion 42 (see FIG. 1) of the sheet conveying portion 2. The second sheet feed control portion 8 is constituted of an electronic circuit such as an integrated circuit (ASIC, DSP).

### Configurations of Image Forming Portion 1 and Sheet Conveying Portion 2

Next, configurations of the image forming portion 1 and the sheet conveying portion 2 will be described with reference to FIG. 1 and FIG. 2.

As shown in FIG. 1, the image forming portion 1 includes a photoconductor drum 21, a charging device 22, a laser scanning unit 23, a developing device 24, a toner container 25, a transfer roller 26, a cleaning device 27, a fixing device 28, and a sheet discharge tray 29.

The photoconductor drum 21 is provided to be rotatable in a direction indicated by an arrow shown in FIG. 1. The charging device 22 charges a circumferential surface of the photoconductor drum 21. The laser scanning unit 23 irradiates light that is based on image data onto the circumferential surface of the photoconductor drum 21 charged by the charging device 22. An electrostatic latent image is formed on the circumferential surface of the photoconductor drum 21 by the laser scanning unit 23.

The developing device 24 uses toner to develop the electrostatic latent image formed on the circumferential surface of the photoconductor drum 21. A toner image is formed on the circumferential surface of the photoconductor drum 21 by the developing device 24. The toner container 25 supplies toner to the developing device 24. The transfer roller 26 transfers the toner image formed by the developing device 24 onto a sheet conveyed by the sheet conveying portion 2. The cleaning device 27 cleans the circumferential surface of the photoconductor drum 21 after the toner image is transferred by the transfer roller 26. The transfer roller 26 is an example of a transfer portion according to the present disclosure.

The fixing device 28 fixes the toner image that has been transferred onto the sheet by the transfer roller 26 onto the sheet. The sheet onto which the toner image has been fixed by the fixing device 28 is discharged onto the sheet discharge tray 29.

As shown in FIG. 1, the sheet conveying portion 2 includes a sheet feed cassette 30, a first conveying path 31, a second conveying path 32, a third conveying path 33, a fourth conveying path 34, and a fifth conveying path 35. It is noted that in FIG. 1, the first conveying path 31, the second conveying path 32, the third conveying path 33, the fourth conveying path 34, and the fifth conveying path 35 are indicated by thick solid lines.

The sheet feed cassette 30 stores sheets on each of which an image is to be formed by the image forming portion 1. For example, the sheet feed cassette 30 stores sheets such as a paper sheet, coated paper, a postcard, an envelope, and an OHP sheet.

The first conveying path 31 is a movement path of the sheet that is provided from the sheet feed cassette 30 to a junction position P11 (see FIG. 1) inside a housing of the image forming apparatus 100. The first conveying path 31 is connected to the second conveying path 32 at the junction position P11. On the first conveying path 31, the sheet is conveyed in a first conveying direction D1 shown in FIG. 1.

The second conveying path 32 is a movement path of the sheet that is provided from the junction position P11 to a branching position P12 (see FIG. 1) inside the housing of the image forming apparatus 100 via a transfer position of the toner image by the transfer roller 26 and the fixing device 28. The second conveying path 32 is connected to the third conveying path 33 and the fourth conveying path 34 at the branching position P12. On the second conveying path 32, the sheet is conveyed in a second conveying direction D2 shown in FIG. 1.

The first conveying path 31 is provided with the first sheet feed portion 41 shown in FIG. 1.

The first sheet feed portion 41 includes a first upstream-side roller 41A, a first downstream-side roller 41B, and a first sheet sensor 41C shown in FIG. 1. The first sheet feed portion 41 also includes a first stepping motor 41D shown in FIG. 2.

As shown in FIG. 1, the first upstream-side roller 41A and the first downstream-side roller 41B are arranged next to each other along the first conveying path 31. The first upstream-side roller 41A is arranged more on an upstream side of the first conveying direction D1 than the first downstream-side roller 41B. The first upstream-side roller 41A and the first downstream-side roller 41B convey a sheet that has been taken out of the sheet feed cassette 30 in the first conveying direction D1.

As shown in FIG. 1, the first sheet sensor 41C is provided between the first upstream-side roller 41A and the first downstream-side roller 41B on the first conveying path 31. The first sheet sensor 41C detects the sheet conveyed by the first upstream-side roller 41A. For example, the first sheet sensor 41C is a reflective or transmissive optical sensor.

The first stepping motor 41D drives the first upstream-side roller 41A and the first downstream-side roller 41B.

On a first sheet feed path (an example of a conveying path according to the present disclosure) that passes through a transfer position of a toner image by the transfer roller 26, the first upstream-side roller 41A and the first downstream-side roller 41B are arranged more on the upstream side of the conveying direction of the sheet than the transfer position. The first sheet feed path is a sheet feed path of the sheet for forming an image on a front surface of the sheet, and is constituted of the first conveying path 31 and the second conveying path 32. The first upstream-side roller 41A and the first downstream-side roller 41B are an example of a conveying member according to the present disclosure.

The first sheet feed portion 41 feeds the sheet from a first sheet feed position P21 shown in FIG. 1. As shown in FIG. 1, the first sheet feed position P21 is a position that is more on the downstream side of the conveying direction of the sheet than the first upstream-side roller 41A and the first downstream-side roller 41B on the first sheet feed path.

Specifically, when one-sided image forming processing for forming an image on one side of a sheet using the image forming portion 1 is executed, the first sheet feed portion 41 feeds a sheet from the first sheet feed position P21 at a predetermined first sheet feed cycle.

In addition, when double-sided image forming processing for forming images on both sides of a sheet using the image forming portion 1 is executed, the first sheet feed portion 41 feeds a sheet from the first sheet feed position P21 at the first sheet feed cycle before a sheet is fed to the second sheet feed portion 42 (see FIG. 1).

Furthermore, when the double-sided image forming processing is executed, after a sheet is fed to the second sheet feed portion 42 (see FIG. 1), the first sheet feed portion 41 feeds a sheet from the first sheet feed position P21 at a second sheet feed cycle that is twice the first sheet feed cycle.

The third conveying path 33 is a movement path of the sheet that is provided from the branching position P12 to the sheet discharge tray 29. On the third conveying path 33, a sheet having an image formed on one or both sides thereof is conveyed in a third conveying direction D3 shown in FIG. 1.

The fourth conveying path 34 is a movement path of the sheet that is provided from the branching position P12 to a sheet discharge port 34A (see FIG. 1) formed at an upper portion of the housing of the image forming apparatus 100. On the fourth conveying path 34, the sheet having an image formed on a front surface thereof is conveyed in a fourth conveying direction D4 shown in FIG. 1.

The sheet discharge port 34A is provided with a reverse conveying roller 34B shown in FIG. 1. The reverse conveying roller 34B switches back the sheet and supplies the sheet to the fifth conveying path 35. Specifically, the reverse conveying roller 34B causes the sheet protrude from the sheet discharge port 34A to the outside of the housing of the image forming apparatus 100 until nipping an end portion of the sheet on the upstream side of the fourth conveying direction D4 (rear end). Then, the reverse conveying roller 34B switches back the sheet by rotating in a reverse direction at a timing at which the rear end of the sheet is nipped. It is noted that a sheet support tray 34C (see FIG. 1) that supports the sheet protruding from the sheet discharge port 34A is formed on an upper surface of the housing of the image forming apparatus 100.

The fifth conveying path 35 is a movement path of the sheet that is provided from the reverse conveying roller 34B to the junction position P11 (see FIG. 1). On the fifth conveying path 35, the sheet having an image formed on a front surface thereof is conveyed in a fifth conveying direction D5 shown in FIG. 1.

The fifth conveying path 35 is provided with the second sheet feed portion 42 shown in FIG. 1.

The second sheet feed portion 42 includes a second upstream-side roller 42A, a second downstream-side roller 42B, and a second sheet sensor 42C shown in FIG. 1. The second sheet feed portion 42 also includes a second stepping motor 42D shown in FIG. 2.

As shown in FIG. 1, the second upstream-side roller 42A and the second downstream-side roller 42B are arranged next to each other along the fifth conveying path 35. The second upstream-side roller 42A is arranged more on the upstream side of the fifth conveying direction D5 than the second downstream-side roller 42B. The second upstream-side roller 42A and the second downstream-side roller 42B convey the sheet conveyed from the reverse conveying roller 34B in the fifth conveying direction D5.

As shown in FIG. 1, the second sheet sensor 42C is provided between the second upstream-side roller 42A and the second downstream-side roller 42B on the fifth conveying path 35. The second sheet sensor 42C detects the sheet conveyed by the second upstream-side roller 42A. For example, the second sheet sensor 42C is a reflective or transmissive optical sensor.

The second stepping motor 42D drives the second upstream-side roller 42A and the second downstream-side roller 42B.

On a second sheet feed path (an example of the conveying path according to the present disclosure) that passes through the transfer position of the toner image by the transfer roller 26, the second upstream-side roller 42A and the second downstream-side roller 42B are arranged more on the upstream side of the conveying direction of the sheet than the transfer position. The second sheet feed path is a sheet feed path of the sheet for forming an image on a back surface of the sheet, and is constituted of the fifth conveying path 35 and the second conveying path 32. The second upstream-side roller 42A and the second downstream-side roller 42B are an example of the conveying member according to the present disclosure.

The second sheet feed portion 42 feeds a sheet from a second sheet feed position P22 shown in FIG. 1. As shown in FIG. 1, the second sheet feed position P22 is a position that is more on the downstream side of the fifth conveying direction D5 than the second upstream-side roller 42A and the second downstream-side roller 42B on the second sheet feed path. In the image forming apparatus 100, the second sheet feed position P22 is determined such that a distance from the first sheet feed position P21 on the first sheet feed path to the transfer position becomes equal to a distance from the second sheet feed position P22 on the second sheet feed path to the transfer position.

Specifically, when the double-sided image forming processing is executed, the second sheet feed portion 42 feeds sheets from the second sheet feed position P22 at the second sheet feed cycle.

In the image forming apparatus 100, when the double-sided image forming processing is executed, sheet feed timings of the first sheet feed portion 41 and second sheet feed portion 42 are set such that the sheet feed timing by the first sheet feed portion 41 and the sheet feed timing by the second sheet feed portion 42 arrive alternately. That is, on the second conveying path 32, a sheet on which an image is to be formed on a front surface thereof and a sheet on which an image is to be formed on a back surface thereof are conveyed alternately. The sheet on which an image has been formed on the front surface thereof by the image forming portion 1 is conveyed to the second sheet feed portion 42 via the fourth conveying path 34. Further, the sheet on which an image has been formed on the back surface thereof by the image forming portion 1 is conveyed to the sheet discharge tray 29 via the third conveying path 33.

Incidentally, there is known, as the related art, an image forming apparatus which stops drive of the second stepping motor 42D until a next sheet feed timing by the second sheet feed portion 42 arrives since a timing at which the sheet has reached the second sheet feed position P22.

Herein, the stepping motor may vibrate for a while after it has stopped. If the drive of the stepping motor is resumed while the stepping motor is vibrating, the behavior of the stepping motor will become unstable.

In the image forming apparatus according to the related art described above, in order to prevent the behavior of the second stepping motor 42D from becoming unstable, it is necessary to set the second sheet feed cycle such that the next sheet feed timing arrives after the vibration following the stop of the second stepping motor 42D has subsided. In other words, in the image forming apparatus according to the related art described above, shortening of intervals of sheet feed operations by the second sheet feed portion 42 is limited. The same holds true for the first sheet feed portion 41.

In contrast, in the image forming apparatus 100 according to the embodiment of the present disclosure, it is possible to shorten the intervals of the sheet feed operations by the first sheet feed portion 41 and the second sheet feed portion 42 as will be described below.

### Configurations of First Sheet Feed Control Portion 7 and Second Sheet Feed Control Portion 8

Next, configurations of the first sheet feed control portion 7 and the second sheet feed control portion 8 will be described with reference to FIG. 2.

As shown in FIG. 2, the first sheet feed control portion 7 includes a first detection processing portion 51 and a first drive control portion 52. It is noted that the CPU 11 of the control portion 6 may execute the control programs stored in the ROM 12 to function as the respective functional portions described above.

The first detection processing portion 51 detects a sheet conveyed by the first upstream-side roller 41A and the first downstream-side roller 41B at a position that is more on the upstream side of the conveying direction of the sheet than the first sheet feed position P21 on the first sheet feed path.

Specifically, the first detection processing portion 51 detects the sheet conveyed by the first upstream-side roller 41A using the first sheet sensor 41C.

The first drive control portion 52 drives the first stepping motor 41D without stopping the first stepping motor 41D so that the sheet reaches the first sheet feed position P21 at a time the next sheet feed timing by the first sheet feed portion 41 arrives based on a detection timing of the sheet by the first detection processing portion 51.

For example, the first drive control portion 52 drives the first stepping motor 41D at a predetermined first rotation speed until a sheet is detected by the first detection processing portion 51. Further, when a sheet is detected by the first detection processing portion 51, the first drive control portion 52 determines a deceleration timing for decelerating the first stepping motor 41D based on the detection timing of the sheet by the first detection processing portion 51. Furthermore, when the determined deceleration timing arrives, the first drive control portion 52 reduces the rotation speed of the first stepping motor 41D from the first rotation speed to a second rotation speed lower than the first rotation speed. Then, when the next sheet feed timing by the first sheet feed portion 41 arrives, the first drive control portion 52 increases the rotation speed of the first stepping motor 41D from the second rotation speed to the first rotation speed. The deceleration timing of the first stepping motor 41D is determined such that the sheet reaches the first sheet feed position P21 at a time the next sheet feed timing by the first sheet feed portion 41 arrives.

As shown in FIG. 2, the second sheet feed control portion 8 includes a second detection processing portion 61 and a second drive control portion 62. It is noted that the CPU 11 of the control portion 6 may execute the control programs stored in the ROM 12 to function as the respective functional portions described above.

The second detection processing portion 61 detects the sheet conveyed by the second upstream-side roller 42A and the second downstream-side roller 42B at a position that is more on the upstream side of the conveying direction of the sheet than the second sheet feed position P22 on the second sheet feed path.

Specifically, the second detection processing portion 61 detects the sheet conveyed by the second upstream-side roller 42A using the second sheet sensor 42C.

The second drive control portion 62 drives the second stepping motor 42D without stopping the second stepping motor 42D so that the sheet reaches the second sheet feed position P22 at a time the next sheet feed timing by the second sheet feed portion 42 arrives based on a detection timing of the sheet by the second detection processing portion 61.

For example, the second drive control portion 62 drives the second stepping motor 42D at the first rotation speed until a sheet is detected by the second detection processing portion 61. Further, when a sheet is detected by the second detection processing portion 61, the second drive control portion 62 determines a deceleration timing for decelerating the second stepping motor 42D based on the detection timing of the sheet by the second detection processing portion 61. Furthermore, when the determined deceleration timing arrives, the second drive control portion 62 reduces the rotation speed of the second stepping motor 42D from the first rotation speed to the second rotation speed. Then, when the next sheet feed timing by the second sheet feed portion 42 arrives, the second drive control portion 62 increases the rotation speed of the second stepping motor 42D from the second rotation speed to the first rotation speed. The deceleration timing of the second stepping motor 42D is determined such that the sheet reaches the second sheet feed position P22 at a time the next sheet feed timing by the second sheet feed portion 42 arrives.

### First Sheet Feed Control Processing

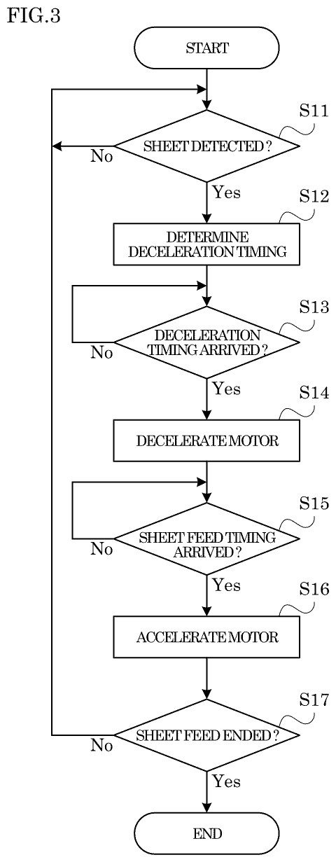

Hereinafter, with reference to FIG. 3, a drive control method according to the present disclosure will be described along with exemplary procedures of first sheet feed control processing executed by the first sheet feed control portion 7 in the image forming apparatus 100. Herein, Step S11, Step S12, . . . represent numbers of processing procedures (steps) executed by the first sheet feed control portion 7.

The first sheet feed control portion 7 executes the first sheet feed control processing when the double-sided image forming processing is executed. It is noted that the first sheet feed control portion 7 may alternatively execute the first sheet feed control processing when the one-sided image forming processing is executed.

### <Step S11>

First, in Step S11, the first sheet feed control portion 7 determines whether or not a sheet conveyed by the first upstream-side roller 41A has been detected by the first sheet sensor 41C. The processing of Step S11 is an example of a detection step according to the present disclosure and is executed by the first detection processing portion 51 of the first sheet feed control portion 7.

Herein, when determining that a sheet has been detected (Yes in S11), the first sheet feed control portion 7 shifts the processing to Step S12. On the other hand, when determining that a sheet has not been detected (No in S11), the first sheet feed control portion 7 waits for the detection of a sheet in Step S11.

### <Step S12>

In Step S12, the first sheet feed control portion 7 determines the deceleration timing for decelerating the rotation speed of the first stepping motor 41D from the first rotation speed to the second rotation speed based on the detection timing of the sheet by the processing of Step S11. This deceleration timing is determined such that the sheet reaches the first sheet feed position P21 at a time the next sheet feed timing by the first sheet feed portion 41 arrives.

### <Step S13>

In Step S13, the first sheet feed control portion 7 determines whether or not the deceleration timing determined by the processing of Step S12 has arrived.

Herein, when determining that the deceleration timing has arrived (Yes in S13), the first sheet feed control portion 7 shifts the processing to Step S14. On the other hand, when determining that the deceleration timing has not arrived (No in S13), the first sheet feed control portion 7 waits for the deceleration timing to arrive in Step S13.

### <Step S14>

In Step S14, the first sheet feed control portion 7 reduces the rotation speed of the first stepping motor 41D from the first rotation speed to the second rotation speed.

### <Step S15>

In Step S15, the first sheet feed control portion 7 determines whether or not the next sheet feed timing by the first sheet feed portion 41 has arrived.

Herein, when determining that the next sheet feed timing has arrived (Yes in S15), the first sheet feed control portion 7 shifts the processing to Step S16. On the other hand, when determining that the next sheet feed timing has not arrived (No in S15), the first sheet feed control portion 7 waits for the arrival of the next sheet feed timing in Step S15.

### <Step S16>

In Step S16, the first sheet feed control portion 7 increases the rotation speed of the first stepping motor 41D from the second rotation speed to the first rotation speed. The processing from Step S12 to Step S16 is an example of a drive control step according to the present disclosure and is executed by the first drive control portion 52 of the first sheet feed control portion 7.

### <Step S17>

In Step S17, the first sheet feed control portion 7 determines whether or not all of the sheets on which images are to be formed by the double-sided image forming processing have been fed by the first sheet feed portion 41.

Herein, when determining that all of the sheets on which images are to be formed by the double-sided image forming processing have been fed by the first sheet feed portion 41 (Yes in S17), the first sheet feed control portion 7 ends the first sheet feed control processing. On the other hand, when determining that all of the sheets on which images are to be formed by the double-sided image forming processing have not been fed by the first sheet feed portion 41 (No in S17), the first sheet feed control portion 7 shifts the processing to Step S11.

### Second Sheet Feed Control Processing

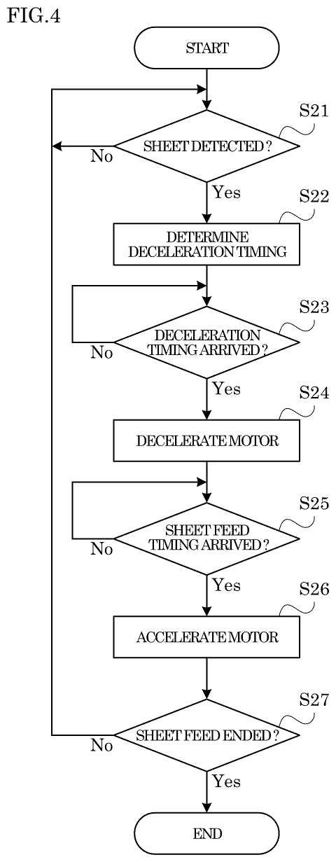

Next, with reference to FIG. 4, the drive control method according to the present disclosure will be described along with exemplary procedures of second sheet feed control processing executed by the second sheet feed control portion 8 in the image forming apparatus 100.

The second sheet feed control portion 8 executes the second sheet feed control processing when the double-sided image forming processing is executed.

### <Step S21>

First, in Step S21, the second sheet feed control portion 8 determines whether or not a sheet conveyed by the second upstream-side roller 42A has been detected by the second sheet sensor 42C. The processing of Step S21 is an example of the detection step according to the present disclosure and is executed by the second detection processing portion 61 of the second sheet feed control portion 8.

Herein, when determining that a sheet has been detected (Yes in S21), the second sheet feed control portion 8 shifts the processing to Step S22. On the other hand, when determining that a sheet has not been detected (No in S21), the second sheet feed control portion 8 waits for the detection of a sheet in Step S21.

### <Step S22>

In Step S22, the second sheet feed control portion 8 determines the deceleration timing for decelerating the rotation speed of the second stepping motor 42D from the first rotation speed to the second rotation speed based on the detection timing of the sheet by the processing of Step S21. This deceleration timing is determined such that the sheet reaches the second sheet feed position P22 at a time the next sheet feed timing by the second sheet feed portion 42 arrives.

### <Step S23>

In Step S23, the second sheet feed control portion 8 determines whether or not the deceleration timing determined by the processing of Step S22 has arrived.

Herein, when determining that the deceleration timing has arrived (Yes in S23), the second sheet feed control portion 8 shifts the processing to Step S24. On the other hand, when determining that the deceleration timing has not arrived (No in S23), the second sheet feed control portion 8 waits for the deceleration timing to arrive in Step S23.

### <Step S24>

In Step S24, the second sheet feed control portion 8 reduces the rotation speed of the second stepping motor 42D from the first rotation speed to the second rotation speed.

### <Step S25>

In Step S25, the second sheet feed control portion 8 determines whether or not the next sheet feed timing by the second sheet feed portion 42 has arrived.

Herein, when determining that the next sheet feed timing has arrived (Yes in S25), the second sheet feed control portion 8 shifts the processing to Step S26. On the other hand, when determining that the next sheet feed timing has not arrived (No in S25), the second sheet feed control portion 8 waits for the arrival of the next sheet feed timing in Step S25.

### <Step S26>

In Step S26, the second sheet feed control portion 8 increases the rotation speed of the second stepping motor 42D from the second rotation speed to the first rotation speed. The processing from Step S22 to Step S26 is an example of the drive control step according to the present disclosure and is executed by the second drive control portion 62 of the second sheet feed control portion 8.

### <Step S27>

In Step S27, the second sheet feed control portion 8 determines whether or not all of the sheets on which images are to be formed by the double-sided image forming processing have been fed by the second sheet feed portion 42.

Herein, when determining that all of the sheets on which images are to be formed by the double-sided image forming processing have been fed by the second sheet feed portion 42 (Yes in S27), the second sheet feed control portion 8 ends the second sheet feed control processing. On the other hand, when determining that all of the sheets on which images are to be formed by the double-sided image forming processing have not been fed by the second sheet feed portion 42 (No in S27), the second sheet feed control portion 8 shifts the processing to Step S21.

In this manner, in the image forming apparatus 100, the second drive control portion 62 drives the second stepping motor 42D such that the sheet reaches the second sheet feed position P22 at a time the next sheet feed timing by the second sheet feed portion 42 arrives based on the detection timing of the sheet by the second detection processing portion 61. In other words, in the image forming apparatus 100, instead of stopping the drive of the second stepping motor 42D at the timing at which the sheet reaches the second sheet feed position P22, the rotation speed of the second stepping motor 42D is decelerated before the sheet reaches the second sheet feed position P22. This makes it possible to feed the sheet at the second sheet feed cycle from the second sheet feed position P22 without stopping the second stepping motor 42D. Therefore, it is possible to shorten the intervals of the sheet feed operations by the second sheet feed portion 42 as compared to the configuration in which the second stepping motor 42D is stopped.

### Notes of Disclosure

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: a transfer portion which transfers a toner image onto a sheet; a sheet feed portion which includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path; a stepping motor which drives the conveying member; a detection processing portion which detects the sheet conveyed by the conveying member at a position that is more on the upstream side of the conveying direction than the sheet feed position on the conveying path; and a drive control portion which drives the stepping motor such that the sheet reaches the sheet feed position at a time a next sheet feed timing by the sheet feed portion arrives based on a detection timing of the sheet by the detection processing portion.

### <Note 2>

A drive control method executed in an image forming apparatus including a transfer portion which transfers a toner image onto a sheet, a sheet feed portion which includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path, and a stepping motor which drives the conveying member, the drive control method including: a detection step of detecting the sheet conveyed by the conveying member at a position that is more on the upstream side of the conveying direction than the sheet feed position on the conveying path; and a drive control step of driving the stepping motor such that the sheet reaches the sheet feed position at a time a next sheet feed timing by the sheet feed portion arrives based on a detection timing of the sheet in the detection step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a transfer portion which transfers a toner image onto a sheet;
a sheet feed portion which includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path;
a stepping motor which drives the conveying member;
a detection processing portion which detects the sheet conveyed by the conveying member at a position that is more on the upstream side of the conveying direction than the sheet feed position on the conveying path; and
a drive control portion which drives the stepping motor such that the sheet reaches the sheet feed position at a time a next sheet feed timing by the sheet feed portion arrives based on a detection timing of the sheet by the detection processing portion.

2. A drive control method executed in an image forming apparatus including a transfer portion which transfers a toner image onto a sheet, a sheet feed portion which includes a conveying member which conveys, on a conveying path of the sheet that passes through a transfer position of the toner image by the transfer portion, the sheet at a position that is more on an upstream side of a conveying direction of the sheet than the transfer position, and feeds the sheet at a predetermined sheet feed cycle from a sheet feed position that is more on a downstream side of the conveying direction than the conveying member on the conveying path, and a stepping motor which drives the conveying member, the drive control method comprising:
a detection step of detecting the sheet conveyed by the conveying member at a position that is more on the upstream side of the conveying direction than the sheet feed position on the conveying path; and
a drive control step of driving the stepping motor such that the sheet reaches the sheet feed position at a time a next sheet feed timing by the sheet feed portion arrives based on a detection timing of the sheet in the detection step.
